(19) United States
(12) Patent Application Publication
(10) Pub. No.: US 2025/0259430 A1
(43) Pub. Date: Aug. 14, 2025

(54) CLIENT-SIDE, PRE-TRAINING PERTURBATION IN FEDERATED LEARNING

(71) Applicant: Cisco Technology, Inc., San Jose, CA (US)

(72) Inventors: Myungjin Lee, Bellevue, WA (US); Gustav Adrian Baumgart, Woodbury, MN (US); Ali Payani, Cupertino, CA (US); Ramana Rao V.R. Kompella, Foster City, CA (US)

(73) Assignee: Cisco Technology, Inc., San Jose, CA (US)

(21) Appl. No.: 18/437,557

(22) Filed: Feb. 9, 2024

(51) Int. Cl. G06V 10/82; G06N 3/045

(52) U.S. Cl. CPC G06V 10/82; G06N 3/045

(57) ABSTRACT

In one embodiment, a device in a federated learning system receives a global model from an aggregation node. The device applies noise to the global model, to form a noise-augmented model. The device performs local training using the noise-augmented model and a local training dataset, to form a local model. The device provides, via a network, the local model to the aggregation node for aggregation with other local models trained in the federated learning system.

### TECHNICAL FIELD

The present disclosure relates generally to computer networks, and, more particularly, to client-side, pre-training perturbation in federated learning.

### BACKGROUND

Federated learning has garnered increased interest in recent years due to its ability to train more robust artificial intelligence (AI)/machine learning (ML) models, as well as its privacy protecting capabilities. For instance, consider the case of a set of different hospitals across the world, each of which stores X-ray images from their own patients. Sharing such medical information to the cloud for model training, or even between one another, may be undesirable (or even illegal), in many circumstances. With federated learning, however, models can be trained at each of the sites and using their own local data. The resulting model parameters can then be aggregated to form a global model that has been trained using the X-ray images across all of the hospitals, but in a manner that does not require those images to actually be shared.

Currently, federated learning deployments mandate that all of the training clients use the same model for each round of training. However, this approach can also be susceptible to nearby local minima, since all clients starts training at the same point, instead of exploring different starting points. This can result in slower convergence and lower accuracy.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example role abstraction model for a machine learning workload;

FIG. 4 illustrates an example of a federated learning system;

FIG. 5 illustrates an example diagram of performing client-side, pre-training perturbation in a federated learning system;

FIG. 6 illustrates an example of the evolution of a global model over time using client-side, pre-training perturbation;

FIGS. 7A-7C illustrate example plots of different noise functions; and

FIG. 8 illustrates an example simplified procedure for performing client-side, pre-training perturbation in a federated learning system.

### DESCRIPTION OF EXAMPLE EMBODIMENTS

### Overview

According to one or more embodiments of the disclosure, a device in a federated learning system receives a global model from an aggregation node. The device applies noise to the global model, to form a noise-augmented model. The device performs local training using the noise-augmented model and a local training dataset, to form a local model. The device provides, via a network, the local model to the aggregation node for aggregation with other local models trained in the federated learning system.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

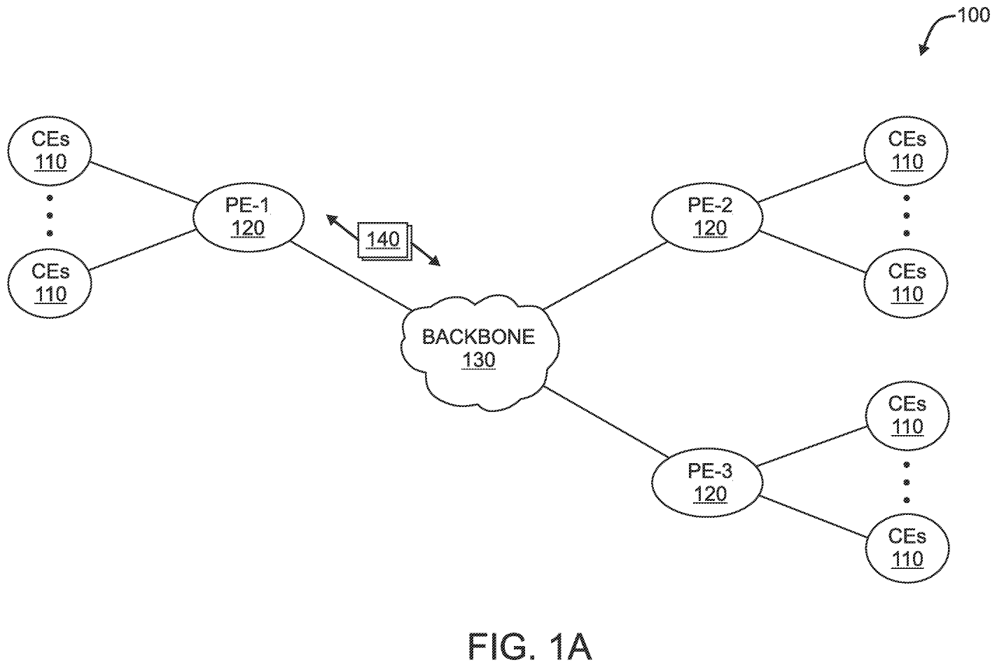

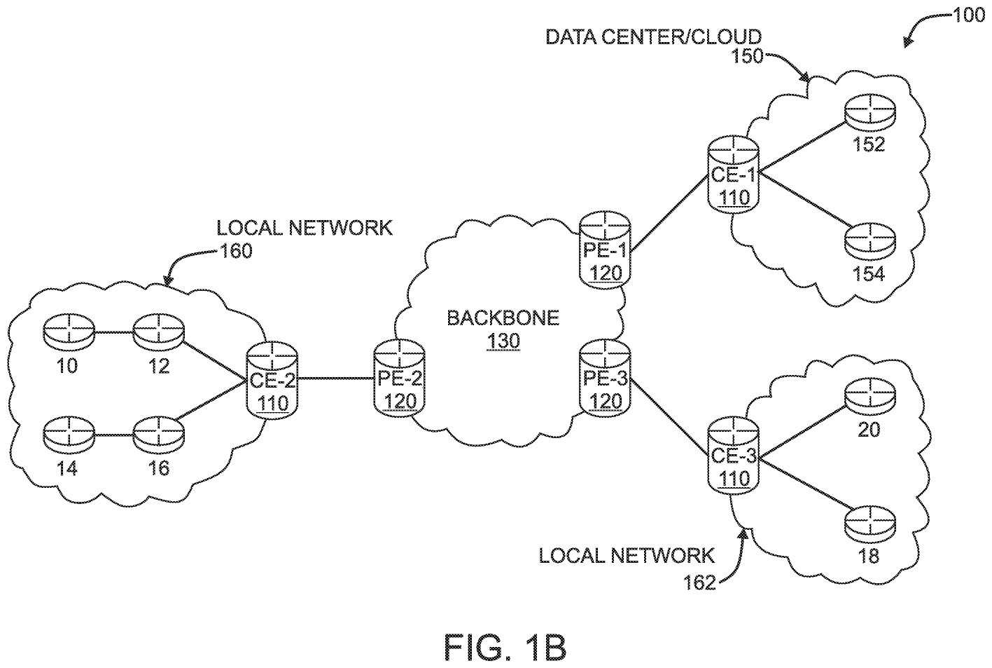

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection). Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

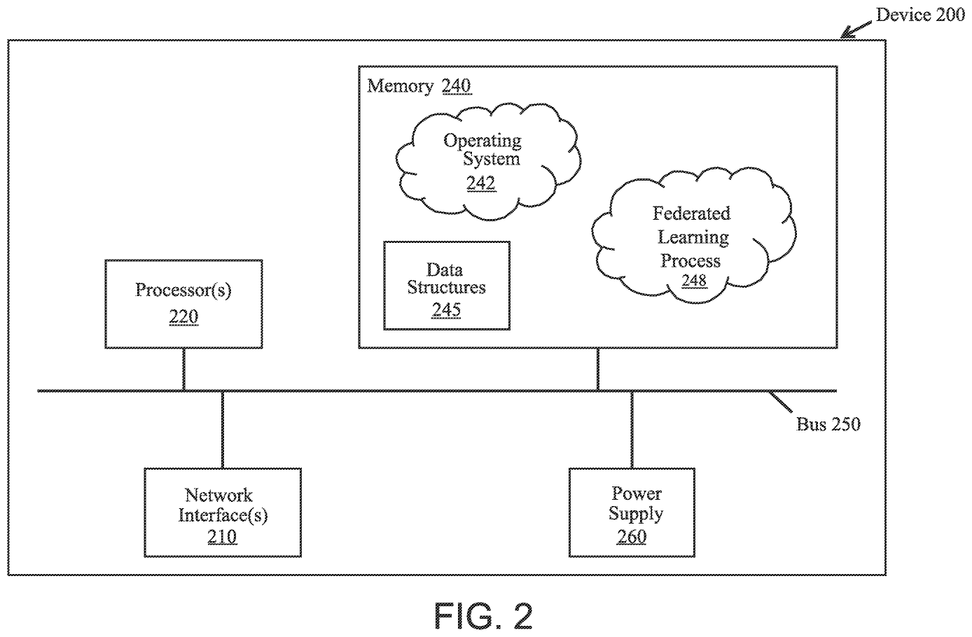

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a federated learning process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, federated learning process 248 may also include computer executable instructions that, when executed by processor(s) 220, cause device 200 to perform the techniques described herein. To do so, in some embodiments, federated learning process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, federated learning process 248 may employ, or be responsible for the deployment of, one or more supervised, unsupervised, or semi-supervised machine learning models. Generally, supervised learning entails the use of a training set of data, as noted above, that is used to train the model to apply labels to the input data. For example, the training data may include sample image data that has been labeled as depicting a particular condition or object. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that federated learning process 248 can employ, or be responsible for deploying, may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

In further implementations, federated learning process 248 may also include and/or train one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that identifies a particular type of object depicted in video data. In such a case, the false positives of the model may refer to the number of times the model incorrectly flagged the video as depicting that object, when it does not. Conversely, the false negatives of the model may refer to the number of times the model failed to identify the presence of the object in the video. True positives and negatives may refer to the number of times the model correctly identified situations in which the video depicted the object or did not depict the object, respectively. Typically, the accuracy of the model refers to the ratio of true positives to the total assessments that the model made. Related to these measurements are also the concepts of recall and precision. Generally, recall refers to the ratio of true positives to the sum of true positives and false negatives, which quantifies the sensitivity of the model. Similarly, precision refers to the ratio of true positives the sum of true and false positives.

Unfortunately, running a machine learning workload is a complex and cumbersome task, today. This is because expressing a machine learning workload is not only tightly coupled with infrastructure resource management, but also embedded into the machine learning library that supports the workload. Consequently, users responsible for machine learning workloads are often faced with time-consuming source code updates and error-prone configuration updates in an ad-hoc fashion for different types of machine learning workloads.

Indeed, as the needs of an application change, this may necessitate changes to the topology of the learning system and/or the algorithms used by its nodes. Typically, such changes have required extensive reworking of the code executed in the learning system, which can be an error-prone and cumbersome endeavor. For instance, consider the case in which a federated learning system is established between several hospitals, each of which uses its own training data to train machine learning models that are then aggregated into a global model. To bring a new hospital online as part of the learning system may require topology changes for better scalability, which would require significant code changes to the learning system across both the new node(s) and the existing nodes.

According to various embodiments, the techniques herein propose decomposing machine learning workloads into primitives/building blocks and decoupling core building blocks (e.g., the AI/ML algorithm) of the workload from the infrastructure building blocks (e.g., network connectivity and communication topology). The infrastructure building blocks are abstracted so that the users can compose their workloads in a simple and declarative manner. In addition, scheduling the workloads is straightforward and foolproof, using the techniques herein.

In various embodiments, the techniques herein propose representing a machine learning workload using the following building block types:
Role—this is logical unit that defines behaviors of a component. Hence, role contains a software piece. Role allows an artificial intelligence (AI)/machine learning (ML) engineer to focus on behaviors of a component associated with a role. At runtime, a role may consist of one or more instances, but the engineer only needs to work on one role at a time during the workload design phase without the need to understand any runtime dependencies or constraints.
Channel—this is a logical unit that abstracts the lower-layer communication mechanisms. In some embodiments, a channel provides a set of application programming interfaces (APIs) that allow one role to communicate with another role. Some of key APIs are ends( ), broadcast( ), send( ), and recv( ). Function ends( ) returns a set of nodes attached to the other end of a given channel. With this function, a node on one side of the channel can choose other nodes at the other end of the channel and subsequently call send( ) and recv( ) to send or receive data with each node. A channel eliminates any source code changes, even when the underlying communication mechanisms change.

Roles and channels may also have various properties associated with them, to control the provisioning of a machine learning workload. In some embodiments, these properties may be categorized as predefined ones and extended ones. Predefined properties may be essential to support the provisioning and set by default, whereas extended properties may be user-defined. In other words, to enrich the functionality of the roles and channels, the user/engineer may opt to customize extended properties.

By way of example, a role may have either or both of the following pre-defined properties:
Replica—this property controls the number of role instances per channel. By default, this may be set to one, meaning there is one role instance per channel. However, a user may elect to set this property to a higher value, as desired.
Load Balance—this property provides the ability to load balance demands given to the role instances and to do fail-overs.

For a channel, there may be the following property:
Group By—this property accepts a list of values so that communication between roles in a channel are controlled by using the specified values. For example, this property can be used to control the communication boundary, such as allowing communications only in a specified geographic area in this property (e.g., U.S., Europe, etc.).

Using the above building blocks and properties, the system can greatly simplify the process for defining a machine learning workload for a user.

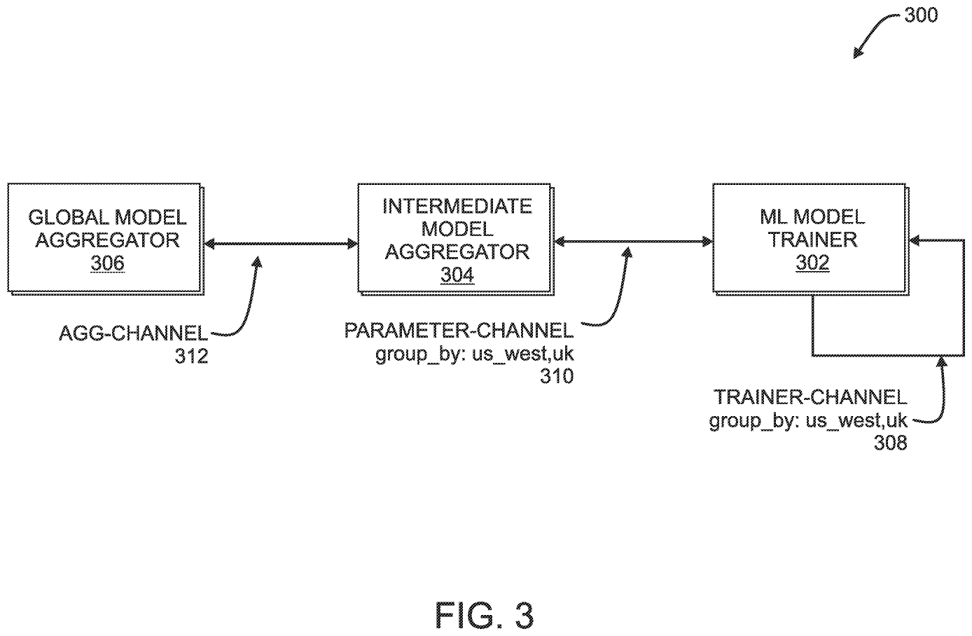

FIG. 3 illustrates an example role abstraction model 300 for a machine learning workload, according to various embodiments. As shown, assume that a user wants to define a machine learning workload to train a machine learning model using data stored at different geographic locations. In a simple implementation, each site could simply transfer their respective datasets to a central location at which a model may be trained on that data. However, there are many instances in which the data is private, thereby preventing it from being sent off-site. For example, the datasets may include personally identifiable information (PII) data, medical data, financial data, or the like, that cannot leave their respective sites.

As shown, role abstraction model 300 consists of three roles for nodes of a federated/distributed learning system: machine learning (ML) model trainer 302, intermediate model aggregator 304, and global model aggregator 306. Connecting them in role abstraction model 300 may be three types of channels: trainer channel 308, parameter channel 310, and aggregation channel 312.

Trainer channels allows communication between peer trainer nodes at runtime. For instance, assume that the group by property is set to group trainer nodes into separate groups located in the western U.S. and the UK. In such a case, trainer channels may be provisioned between these nodes. Similarly, a parameter channel may enable communications between intermediate model aggregators, such as intermediate model aggregator 304 and trainer nodes in the various groups, such as model trainer 302. Finally, an aggregation channel may connect the intermediate model aggregator to global model aggregator 306.

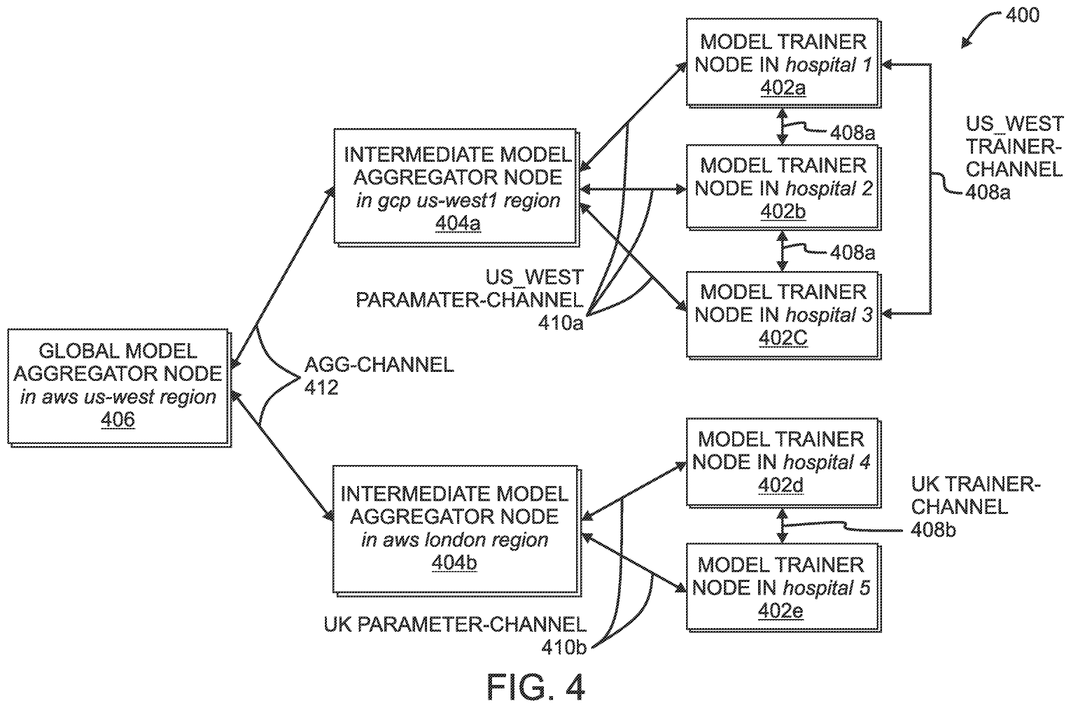

FIG. 4 illustrates an example of a machine learning workload 400 defined in accordance with role abstraction model 300 of FIG. 3, according to various embodiments. As shown, assume that the goal of the machine learning workload is to train a machine learning model to detect certain features (e.g., tumors, etc.) within a certain type of medical data (e.g., X-rays, MRI images, etc.) in a federated manner. Such medical data may be stored at different hospitals or other locations across different geographic locations. For instance, assume that the medical data is spread across different hospitals located in the UK and the western US, each of which maintains its own training dataset.

To provision the machine learning workload across the different hospitals, a user may convey, via a user interface, definition data for the workload. For instance, the user may specify the type of model to be trained, values for the replica property, the number of datasets to use, tags for the group by property, any values for the load balancing property, combinations thereof, or the like.

Based on the definition data, the system may identify that the needed training datasets are located at nodes 402a-402e (e.g., the different hospitals). Note that the user does not need to know where the data is located during the design phase for machine learning workload 400, as the system may automatically identify nodes 402a-402e, automatically, using an index of their available data. In turn, the system may designate each of nodes 402a-402e as having training roles, meaning that each one is to train a machine learning model in accordance with the definition data and using its own local training dataset. In other words, once the system has identified nodes 402a-402e as each having training datasets matching the requisite type of data for the training, the system may provision and configure each of these nodes with a trainer role.

Assume now that the group by property has been set to group nodes 402a-402e by their geographic locations. Consequently, nodes 402a-402c may be grouped into a first group of trainer/training nodes, based on these hospitals all being located in the western US, by being tagged with a “us_west” tag. Similarly, nodes 402d-402e may be grouped into a second group of training nodes, based on these hospitals being located in the UK, by being tagged with a “uk tag.

For purposes of simplifying this example, also assume that the replica property is set to 1, by default, meaning that there is only one trainer role instance to be configured at each of nodes 402a-402e.

To connect the different sites/nodes 402a-402e in each group, the system may also provision and configure trainer channels between the nodes in each group. For instance, the system may configure trainer channels 408a between nodes 402a-402c within the first geographic group of nodes, as well as a trainer channel 408b between nodes 402d-402e in the second geographic group of nodes.

Once the system has identified nodes 402a-402e, it may also identify intermediate model aggregator nodes 404a-404b, to support the groups of nodes 402a-402c and 402d-402e, respectively. In turn, the system may configure model aggregator nodes 404a-404b with intermediate model aggregation roles. In addition, the system may configure parameter channels 410a-410b to connect the groups of nodes 402a-402c and 402d-402e with intermediate model aggregator nodes 404a-404b, respectively. These parameter channels 410a-410b, like their respective groups of nodes 402, may be tagged with the ‘us_west’ and ‘uk’ tags, respectively. In some instances, intermediate model aggregator nodes 404a-404b may be selected based on their distances or proximities to their assigned nodes among nodes 402a-402e. For instance, intermediate model aggregator node 404b may be cloud-based and selected based on it being in the same geographic region as nodes 402d-402e. Indeed, intermediate model aggregator node 404a may be provisioned in the Google cloud (gcp) in the western US, while intermediate model aggregator node 404b may be provisioned in the Amazon cloud (AWS) in the UK region.

During execution, each trainer node 402a-402e may train a machine learning model using its own local training dataset. In turn, nodes 402a-402e may send the parameters of these trained models to their respective intermediate model aggregator nodes 404a-404b via parameter channels 410a-410b. Using these parameters, each of intermediate model aggregator nodes 404a-404b may form an aggregate machine learning model. More specifically, intermediate model aggregator node 404a may aggregate the models trained by nodes 402a-402c into a first intermediate model and intermediate model aggregator node 404b may aggregate the models trained by nodes 402d-402e into a second aggregate model.

Finally, the system may also provision machine learning workload 400 in part by selecting and configuring global model aggregator node 406. Here, the system may configure a global aggregation role to global model aggregator node 406 and configure aggregation channels 412 that connect it to intermediate model aggregator nodes 404a-404b. Note that these aggregation channels may not be tagged with a geographic tag, either.

Once configured and provisioned, intermediate model aggregator nodes 404a-404b may send the parameters for their respective intermediate models to global model aggregator node 406 via aggregation channels 412. In turn, global model aggregator node 406 may use these model parameters to form a global, aggregated machine learning model that can then be distributed for execution. As a result of the provisioning by the system, the resulting global model will be based on the disparate training datasets across nodes 402a-402e, and in a way that greatly simplifies the definition process of the machine learning workload used to train the model.

As would be appreciated, the layout in which nodes are deployed and connected in a federated learning system is called a topology of the system. In general, the topology used to deploy a federated learning solution for an application depends on multiple factors such as data origin, regulatory requirements, resource/budget availability, combinations thereof, and the like.

In traditional systems (e.g., Tensorflow, etc.), developers typically build their own federated learning topologies from scratch using various primitives. However, with time as the application starts to grow and data source origin changes (e.g., increases or decreases) the deployed federated learning topology is also required to be updated. This often requires significant changes to the underlying system to implement such a topology change. In addition, once the changes have been implemented, the underlying system still needs to be tested before redeployment. Additionally, if a developer wishes to evaluate different algorithms to analyze the data, the entire process will need to be performed again, to redeploy the learning system.

According to various embodiments, the role abstraction model herein can be used to facilitate changes to the topology of a federated learning system in a simplified manner and/or update the learning algorithms used on the different nodes in the system (e.g., FedAvg, FedProxy, etc.). More specifically, since the role abstraction model abstracts the machine learning code from the topology deployment, the topology can be updated in a simplified manner without requiring the developer to make code changes, manually.

Of course, a federated learning system may be implemented in any number of ways and the above approach using predefined communication channels and roles represents only a portion of possible implementations.

As noted above, traditional federated learning mandates that each trainer node (e.g., trainer nodes 402 in FIG. 4) use the same model for each round of training. However, doing so is also susceptible to local minima, since all clients start training at the same point, rather than exploring different starting points. This can result in slower convergence and lower accuracy.

### ——Client-Side, Pre-Training Perturbation in Federated Learning——

The techniques introduced herein help to increase both convergence time and model accuracy in a federated learning system by performing pre-training perturbation at each trainer client. In some aspects, teach trainer may do so by first injecting noise into the global model that it receives, prior to using that model to perform local training using its own training dataset. This allows the local training to effectively cover a larger portion of the learning space, leading to improved performance of both the federated learning system, as well as the resulting model.

Before delving into the techniques herein, it should be noted that some techniques, such as differential privacy, may add noise at the client-side, to help obfuscate any personally identifiable information (PII) available to a trainer client. Indeed, local training at a trainer node can sometimes lead to the locally-trained model learning about the PII within the local training dataset, inadvertently exposing the PII externally. However, such noise is injected in differential privacy after training of the local model, whereas the techniques herein inject noise prior to local training, as the two techniques seek to achieve different goals. Indeed, injecting noise prior to local training helps to mitigate against the local minima issue by letting each client start from different points in the learning space (or search space). Of course, differential privacy could still be used in conjunction with the techniques herein, as desired.

Illustratively, the techniques described herein may be performed by hardware, software, and/or firmware, such as in accordance with federated learning process 248, which may include computer executable instructions executed by the processor 220 (or independent processor of interfaces 210) to perform functions relating to the techniques described herein.

Specifically, according to various embodiments, a device in a federated learning system receives a global model from an aggregation node. The device applies noise to the global model, to form a noise-augmented model. The device performs local training using the noise-augmented model and a local training dataset, to form a local model. The device provides, via a network, the local model to the aggregation node for aggregation with other local models trained in the federated learning system.

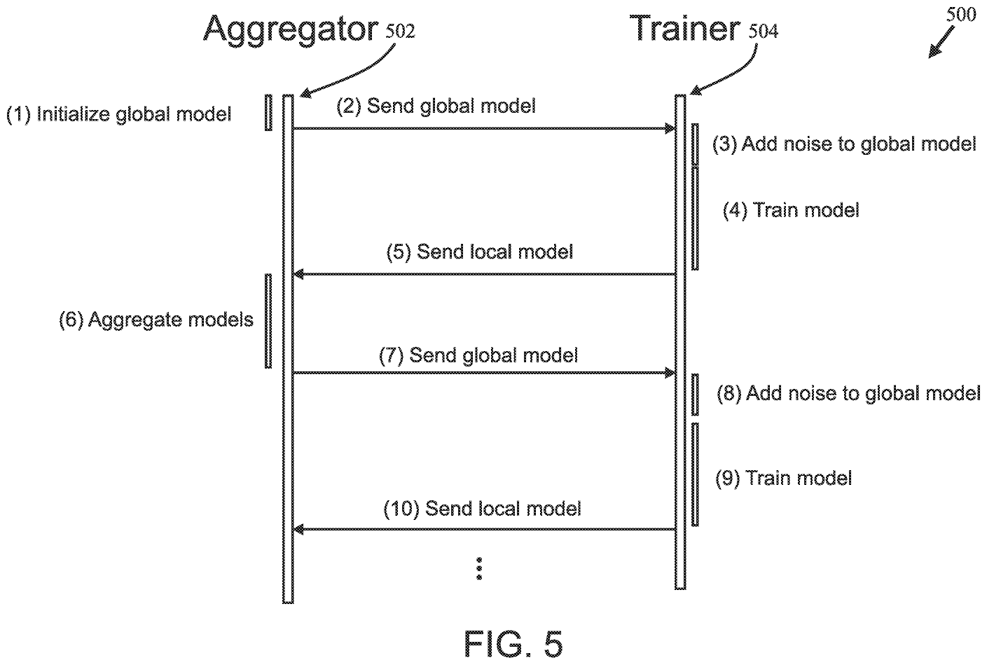

Operationally, FIG. 5 illustrates an example diagram 500 of performing client-side, pre-training perturbation in a federated learning system, according to various embodiments. As shown, diagram 500 illustrates the interactions of an aggregator 502 and a trainer 504 within a federated learning system. For simplicity, aggregator 502 may take the form of a global aggregator that communicates directly with trainer 504. Of course, any number of intermediate aggregators could also be used, in further implementations.

During operation of the federated learning system, aggregator 502 and trainer 504 may interact with one another as follows:
Step 1: aggregator 502 initializes the global model
Step 2: aggregator 502 sends the global model to trainer 504 via the network
Step 3: trainer 504 adds noise to the global model
Step 4: trainer 504 trains a local model using the noise-augmented global model
Step 5: trainer 504 sends its local model back to aggregator 502
Step 6: aggregator 502 aggregates the local models from trainer 504 and the other trainers in the federated learning system, to form an updated global model
Step 7: aggregator 502 then sends the updated global model to trainer 504 (and to the other trainers)
Step 8: trainer 504 adds noise to the updated global model
Step 9: trainer 504 trains a local model using the noise-augmented global model
Step 10: trainer 504 sends its local model back to aggregator 502
Etc.

This process may repeat any number of times until the global model is sufficiently trained to perform its intended tasks (e.g., classification, inference, etc.). As would be appreciated, by adding noise to the global model prior to performing local training, this allows the trainer clients to start from different points in the learning space (or search space), thereby mitigating against the likelihood of falling into local minima.

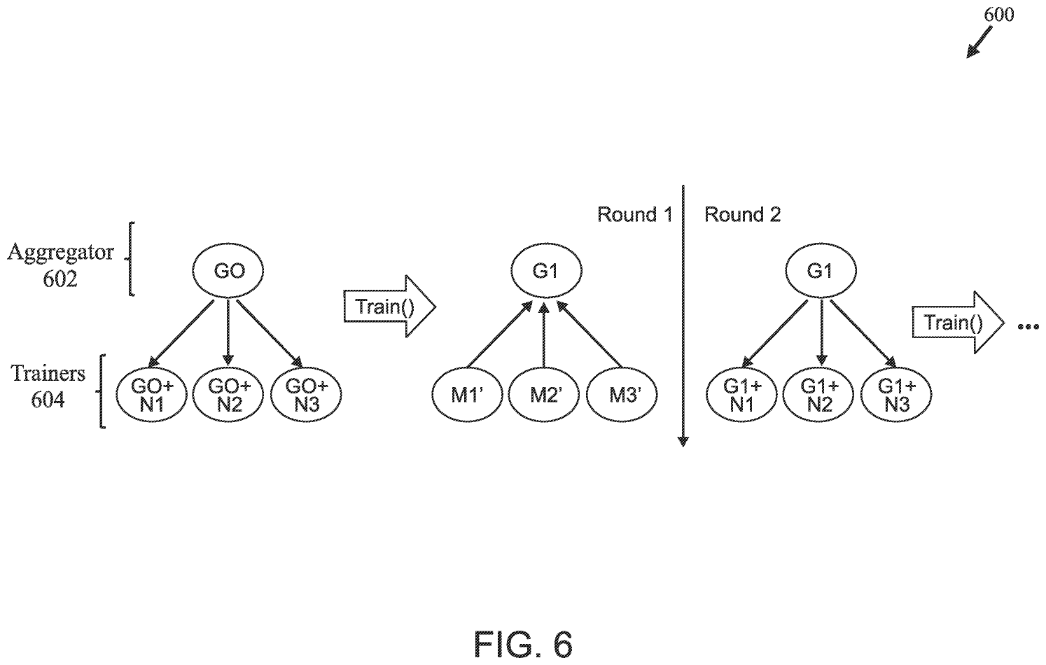

FIG. 6 illustrates an example 600 of the evolution of a global model over time using client-side, pre-training perturbation, in various implementations. As shown, again assume a simple federated learning topology with a singular aggregator 602 and multiple trainers 604 (e.g., nodes N1-N3 shown). During a first round of training, aggregator 602 may first send global model G0 to each of trainers 604. In turn, each of trainers 604 may apply noise to model G0, thereby forming models G0+, locally.

Once each of trainers 604 has formed a corresponding model G0+, it may initiate local training using its own local training dataset. Consequently, trainers 604 will produce their own respective local models M1′, M2′, and M3′. Trainers 604 then send these local models back to aggregator 602 for aggregation into an updated global model G1.

As would be appreciated, the federated learning system may perform any number of training rounds in a similar manner. For instance, in example 600, aggregator 602 may initiate a second round of training by sending global model G1 to trainers 604, which then apply noise to this model before performing additional local training. The number of training rounds may be fixed (e.g., according to a predefined parameter or specified by an administrator), may be a function of a desired level of performance of the resulting global model (e.g., ‘train until an accuracy of X,’ etc.), or the like.

In some implementation, an administrator of the federated learning system may be able to specific (e.g., via a user interface) the amount of noise that each trainer node adds before performing local training. For instance, for fresh training (i.e., without a pre-trained model), the noise level may be set relatively high. On the other hand, in the presence of a pre-trained model, adding too much noise could lead to slow down convergence rate.

Various noise addition functions are also possible, in various implementations. For instance, an administrator for the federated learning system may define or specify these functions, on an individual basis for each trainer node, for different sets of trainer nodes, or across the full set of trainer nodes. In addition, the noise level may also be specified by an administrator (e.g., via a user interface).

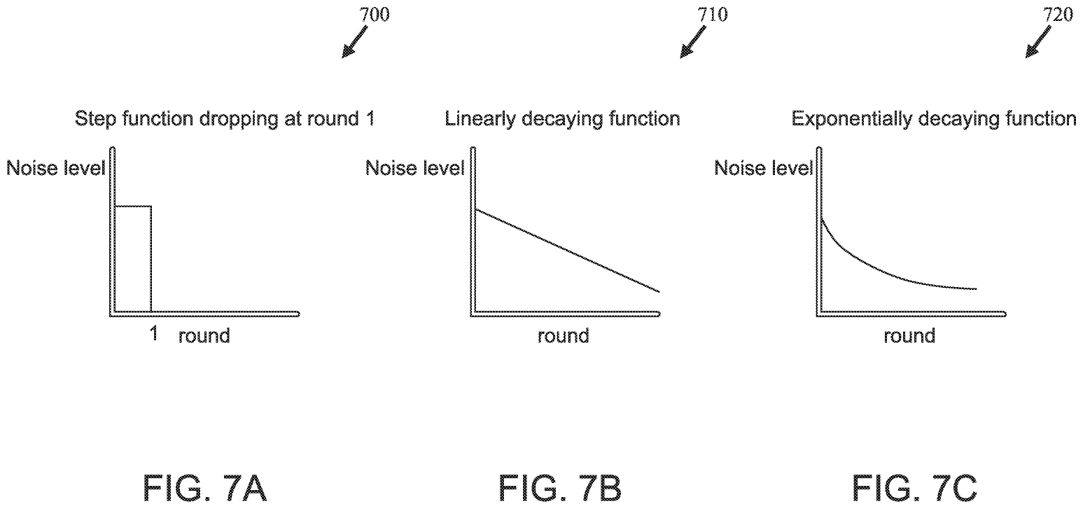

FIGS. 7A-7C illustrate example plots of different noise functions, in some instances. More specifically, FIG. 7A illustrates a plot 700 of a first noise function that takes the form of a step function whereby a trainer node applies a set amount of noise during n-number of training rounds (e.g., a first round, as shown), followed by the addition of no noise in subsequent training rounds. In contrast, FIG. 7B illustrates a plot 710 whereby the noise function takes the form of a linearly decaying function. In such a case, the trainer node may apply a certain amount of noise during the first training round, followed by linearly decreasing amounts of noise in subsequent rounds. Finally, FIG. 7C illustrates a plot 720 showing an exponentially decaying noise function, whereby the trainer node applies a defined amount of noise during the first training round, followed by an exponentially decreasing amount of noise in subsequent rounds.

As would be appreciated, the noise functions shown in FIGS. 7A-7C are exemplary only and the administrator of the federated learning system may opt to define or apply different noise functions, as desired. In addition, in some cases, the administrator may opt to have one trainer node use one noise function, while another trainer node uses a different noise function.

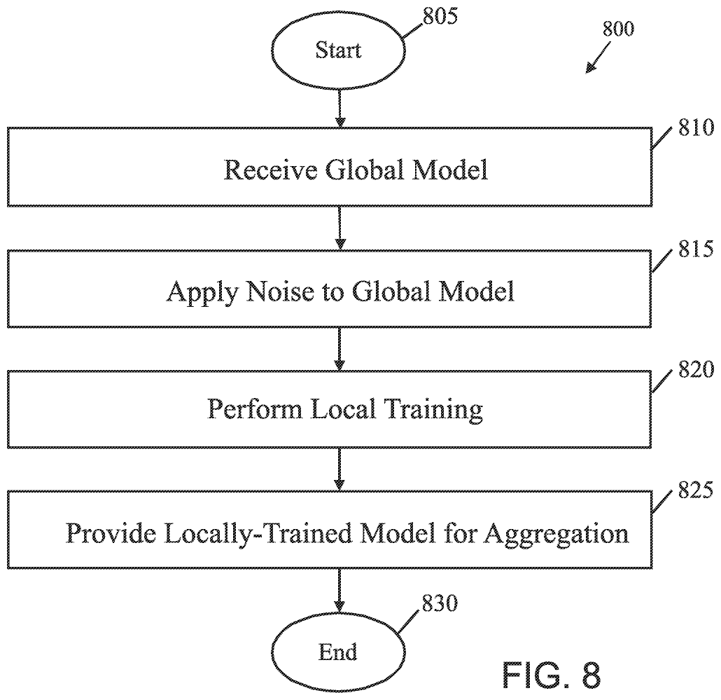

FIG. 8 illustrates an example simplified procedure 800 (e.g., a method) for performing client-side, pre-training perturbation in a federated learning system, in accordance with one or more implementations described herein. For example, a non-generic, specifically configured device (e.g., a device 200) in a federated learning system, may perform procedure 800 by executing stored instructions (e.g., federated learning process 248). The procedure 800 may start at step 805, and continues to step 810, where, as described in greater detail above, the device may receive, a global model from an aggregation node in a federated learning system. In various instances, the global model is configured to classify sensor data.

At step 815, as detailed above, the device may apply noise to the global model, to form a noise-augmented model. In various implementations, the device and one or more other trainer nodes in the federated learning system apply different levels of noise to the global model. In some implementations, the device applies noise to the global model according to a noise profile specified via a user interface. In one implementation, the noise profile comprises a decreasing step function across a plurality of training rounds. In another implementation, the noise profile comprises a linearly decaying noise function across a plurality of training rounds. In a further implementation, the noise profile comprises an exponentially decaying noise function across a plurality of training rounds.

At step 820, the device may perform local training using the noise-augmented model and a local training dataset, to form a local model, as described in greater detail above. In some implementations, the local training dataset comprises images or video.

At step 825, as detailed above, the device may provide, via a network, the local model to the aggregation node for aggregation with other local models trained in the federated learning system. In some cases, the aggregation node aggregates the local model with the other local models to update the global model. In another implementation, the aggregation node is an intermediate aggregation node in the federated learning system.

Procedure 800 then ends at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for client-side, pre-training perturbation in federated learning, it is to be understood that various other adaptations and modifications may be made within the spirit and scope of the embodiments herein. For example, while certain embodiments are described herein with respect to machine learning workloads directed towards model training, the techniques herein are not limited as such and may be used for other types of machine learning tasks, such as making inferences or predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
receiving, at a device in a federated learning system, a global model from an aggregation node;
applying, by the device, noise to the global model, to form a noise-augmented model;
performing, by the device, local training using the noise-augmented model and a local training dataset, to form a local model; and
providing, by the device and via a network, the local model to the aggregation node for aggregation with other local models trained in the federated learning system.

2. The method as in claim 1, wherein the local training dataset comprises images or video.

3. The method as in claim 1, wherein the aggregation node aggregates the local model with the other local models to update the global model.

4. The method as in claim 1, wherein the device and one or more other trainer nodes in the federated learning system apply different levels of noise to the global model.

5. The method as in claim 1, wherein the device applies noise to the global model according to a noise profile specified via a user interface.

6. The method as in claim 5, wherein the noise profile comprises a decreasing step function across a plurality of training rounds.

7. The method as in claim 5, wherein the noise profile comprises a linearly decaying noise function across a plurality of training rounds.

8. The method as in claim 5, wherein the noise profile comprises an exponentially decaying noise function across a plurality of training rounds.

9. The method as in claim 1, wherein the aggregation node is an intermediate aggregation node in the federated learning system.

10. The method as in claim 1, wherein the global model is configured to classify sensor data.

11. An apparatus, comprising:
one or more network interfaces;
a processor coupled to the one or more network interfaces and configured to execute one or more processes; and
a memory configured to store a process that is executable by the processor, the process when executed configured to:
receive, a global model from an aggregation node in a federated learning system;
apply noise to the global model, to form a noise-augmented model;
perform local training using the noise-augmented model and a local training dataset, to form a local model; and
provide, via a network, the local model to the aggregation node for aggregation with other local models trained in the federated learning system.

12. The apparatus as in claim 11, wherein the local training dataset comprises images or video.

13. The apparatus as in claim 11, wherein the aggregation node aggregates the local model with the other local models to update the global model.

14. The apparatus as in claim 11, wherein the apparatus and one or more other trainer nodes in the federated learning system apply different levels of noise to the global model.

15. The apparatus as in claim 11, wherein the apparatus applies noise to the global model according to a noise profile specified via a user interface.

16. The apparatus as in claim 15, wherein the noise profile comprises a decreasing step function across a plurality of training rounds.

17. The apparatus as in claim 15, wherein the noise profile comprises a linearly decaying noise function across a plurality of training rounds.

18. The apparatus as in claim 15, wherein the noise profile comprises an exponentially decaying noise function across a plurality of training rounds.

19. The apparatus as in claim 11, wherein the aggregation node is an intermediate aggregation node in the federated learning system.

20. A tangible, non-transitory, computer-readable medium storing program instructions that cause a device in a federated learning system to execute a process comprising:
receiving, at the device in the federated learning system, a global model from an aggregation node;
applying, by the device, noise to the global model, to form a noise-augmented model;
performing, by the device, local training using the noise-augmented model and a local training dataset, to form a local model; and
providing, by the device and via a network, the local model to the aggregation node for aggregation with other local models trained in the federated learning system.
